(19) United States
(12) Patent Application Publication
(10) Pub. No.: US 2023/0332258 A1
(43) Pub. Date: Oct. 19, 2023

(54) BIOMASS DIRECT REDUCED IRON

(71) Applicant: Technological Resources Pty. Limited, Melbourne (AU)

(72) Inventors: Rodney James Dry, City Beach, Western Australia (AU); Iain William Farr, Perth, Western Australia (AU)

(21) Appl. No.: 18/027,409

(22) PCT Filed: Sep. 20, 2021
(86) PCT No.: PCT/AU2021/051094

§ 371 Date: Mar. 21, 2023

(30) Foreign Application Priority Data
Sep. 22, 2020 (AU) 2020903398

(51) Int. Cl. C21B 13/00

(52) U.S. Cl. CPC C21B 13/004; C21B 13/0066

(57) ABSTRACT

A method for producing direct reduced iron (“DRI”) from iron ore and biomass is disclosed. The method includes heating a batch of iron ore and biomass in each oven chamber of a non-recovery batch oven by a combination (i) the thermal mass of a lining of the oven chamber and (ii) combustion of a fuel gas from at least one other oven chamber and at least partially reducing the iron ore and forming DRI. The method also includes discharging gases from the oven chamber through passageways in a wall and a floor of the oven chamber and further combusting combustible gases and transferring heat to the wall and the floor of the oven chamber as the gases move through the passageways. The method also includes discharging at least a portion of gases from the oven chamber, without passing the gases through passageways in the floor of the oven chamber, and using these gases as a fuel gas in subsequent combustion heating in other batch oven chambers when a first predetermined trigger point is reached. A non-recovery batch oven is also disclosed.

### TECHNICAL FIELD

The present invention relates to a method for producing direct reduced iron (“DRI”) from iron ore and biomass.

The present invention relates particularly, although by no means exclusively, to a process and an apparatus for producing DRI in multiple interlinked static batch ovens. This term describes arrangements of ovens that are collectively referred to as a battery oven in the case of coke production.

The present invention also relates to a non-recovery oven, as described herein, for producing DRI from iron ore and biomass.

DRI produced in these ovens, while still retaining residual heat, may be subsequently melted in a furnace to create hot metal, then cast as pig iron or refined further to steel in a furnace.

Alternatively, the hot DRI may be compressed between a pair of rollers (with aligning pockets) to form a product known as “hot briquetted iron” (HBI), which can subsequently be supplied to a furnace as a cold charge.

The term “direct reduced iron” is understood herein to mean iron produced from the direct reduction of iron ore (in the form of lumps, pellets, briquettes, or fines) to iron by a reducing agent at temperatures below the bulk melting temperature of the solids. For the purposes of the discussion herein “direct reduced iron” (DRI) will be understood to have at least 85% metallisation.

The term “metallisation” is understood to mean the extent of conversion of iron oxide into metallic iron during reduction of the iron oxide, as a percentage of the mass of metallic iron divided by the mass of total iron.

The present invention also relates to a method and an apparatus for producing molten metal (such as pig iron or steel) from DRI.

### BACKGROUND

Iron and steel making are historically carbon intensive processes in which the majority of the carbon used is eventually oxidised to CO₂ and discharged to the atmosphere. With the world seeking to reduce overall atmospheric CO₂ there is pressure on iron and steel makers to find means to make iron and steel without causing net emissions of greenhouse gases. In particular there is pressure to not use coal and natural gas, which are considered non-renewable.

The majority of iron in the world is produced by the blast furnace route, which is a technology that has existed since prior to the industrial revolution. Even with technology advances the blast furnace currently still requires around 800 kg of metallurgical coal for every tonne of iron produced and emits high levels of CO₂, roughly 1.8-2.0 t CO₂ per tonne of hot metal. The use of fossil fuels, in particular the requirement for coal (in the form of coke), is an essential feed material for a blast furnace to operate, and it is not possible to simply use hydrogen therein as a complete substitute.

One alternative to blast furnaces is the production of DRI using hydrogen from iron ores (in the form of an indurated pellet feed) followed by smelting in an EAF to produce steel. For this route to be carbon neutral it requires conversion of renewable (green) energy into hydrogen (particularly in periods when wind/solar power cost is low), with subsequent production of DRI using the hydrogen. This route has strong support in Europe and has the potential to become a significant part of the global solution (1). However, there are limitations, as follows.
1. The amount of electricity needed is high (3000-4000 kWh/t) and green power cost needs to be low (or in the alternate a high carbon tax) for it to become cost-effective. Wind and solar power are periodic and thus hydrogen needs to be produced in excess of immediate requirements.
2. Storage and supply of large amounts of hydrogen is a technical challenge. Underground salt caverns and exhausted natural gas reservoirs appear to show good potential. However, not all geographical locations may be amenable to this type of hydrogen storage. Moreover, suitable storage locations may not be close to DRI facilities for existing EAF steel mills and/or integrated steelmaking facilities, resulting in supply challenges.
3. Only low-gangue ore types (or those able to readily be upgraded to remove gangue) can be used with the DRI/EAF combination. The EAF will penalise high gangue ore types strongly, rendering them essentially non-competitive. This implies most of the ore currently used in blast furnaces could become sub-economic for such a process route.

It is known that biomass could be a complementary part of a sustainable solution, acting as a substitute for fossil fuels, without causing net emissions of greenhouse gases.

Burning of either fossil fuels or biomass will release CO₂. However, when fast growing plants are the source of the biomass, they are largely a carbon-neutral energy source, as through photosynthesis around the same amount of CO₂ is taken up when the plants are regrown.

To date there is no large-scale commercial iron making process that uses biomass directly. Previous attempts to insert some biomass into processes originally designed for coal (e.g. blast furnaces and coke ovens) are marginal at best and usually quite disappointing in terms of overall CO₂ impact. This is largely because the nature of biomass is vastly different to that of coal. To use biomass successfully it is necessary to re-design the process around the fundamental nature of biomass.

Biomass can take many forms. Avoiding competition with food production is a key issue for biomass selection. Examples of biomass that might meet such criteria include elephant grass, sugar cane bagasse, wood waste, excess straw, azolla and seaweed. Such biomass availability varies considerably from one geographic location to another—and will most likely be a significant factor in determining the size and location of future biomass-based iron plants given the volume of material required and the economic challenges in transporting such material long distances.

Various lab-scale studies (2) have shown that iron ores tested by mixing the ores with biomass and heating the mixtures in a small furnace can produce DRI in a manner that appears (superficially) somewhat better than that expected from first principles. Although the reasons may not be clear, the result stands as a technical “sweet spot”. The technical challenge is how to perform this efficiently at large scale.

There are many possible approaches. One of these approaches (currently being developed by the applicant) involves briquetting ore and biomass, then using a linear or rotary heath furnace (or a rotary kiln) to preheat the material to around 800-900° C. to devolatilise it. Ore pre-reduction is expected to reach around 40-70% under these conditions. This is followed by a microwave treatment stage where the briquettes are heated to around 1000-1100° C. and reduced (using residual bio-carbon) further, with reductions typically around 90-95% and in some instances up to almost full metallisation. This DRI may then be fed to an open-arc furnace or an induction furnace to produce pig iron.

The present invention is an alternative method for the production of DRI using biomass.

The above description is not to be taken as an admission of the common general knowledge in Australia or elsewhere.

### SUMMARY OF THE DISCLOSURE

The present invention is based on a realisation that an adapted form of a non-recovery coke oven, i.e. an oven for iron ore and biomass that is similar in principle to a non-recovery coke oven, could provide an efficient way of heating and reducing ore-biomass on a batch basis.

The present invention is also based on a realisation that the adapted form of the non-recovery coke oven could be used in a modified form of a method for producing direct reduced iron (“DRI”) from iron ore and biomass described in International application PCT/AU2021/050252 lodged on 19 Mar. 2021, with a claim to priority from Australian provisional application 2020900862 lodged on 20 Mar. 2020, in the name of the applicant. The disclosure in the specification lodged with the International application is incorporated herein by cross-reference. The process described in the International application includes heating a batch of iron ore and biomass in a batch oven in a temperature range of 700-1100 □C in a batch cycle time of 10-100 hours and reducing iron ore and forming a solid DRI product having a metallisation of 80-99%, typically 90-99%, and generating an off-gas and discharging the solid product at the end of the batch cycle and discharging off-gas during the course of the batch cycle.

The term “non-recovery coke oven” includes ovens of the type described in U.S. Pat. No. 5,318,671 in the name of Sun Coal Company and the disclosure in the specification of the US patent is incorporated herein by cross reference. It is noted that the extent of the adaption of a non-recovery coke oven that is required to construct a non-recovery oven for iron ore and biomass in accordance with the invention will be evident from the following sections of the specification.

In broad terms, the present invention provides a method for producing direct reduced iron (“DRI”) from iron ore and biomass is disclosed. The method includes heating a batch of iron ore and biomass in each oven chamber of a non-recovery batch oven by a combination (i) the thermal mass of the lining of the oven chamber and (ii) combustion of a fuel gas from at least one other oven chamber and at least partially reducing the iron ore and forming DRI. The method also includes discharging gases from the oven chamber through passageways in a wall and a floor of the oven chamber and further combusting combustible gases and transferring heat to the wall and the floor of the oven chamber as the gases move through the passageways. The method also includes discharging at least a portion of gases from the oven chamber, without passing the gases through passageways in the floor (and optionally the wall) of the oven chamber, and using these gases as a fuel gas in subsequent combustion heating in other batch oven chambers when a first predetermined trigger point is reached.

In more particular terms, the present invention provides a method for producing direct reduced iron (“DRI”) from iron ore and biomass using a non-recovery batch oven, as described herein that is configured to be similar in principle to a non-recovery coke oven, in a batch cycle mode of operation, with the non-recovery oven having a plurality of separate batch ovens forming a battery of batch ovens, with each batch oven having a chamber defined by a refractory-lined wall and floor having a thermal mass and each having a plurality of burners, and the oven chambers having shared fuel gas and off-gas offtakes, with the method including the following steps in at least one batch oven:
a) charging a batch of composite of iron ore and biomass, as described herein, into the batch oven chamber;
b) heating the charged iron ore and biomass in each oven chamber by a combination of heat from (i) the thermal mass of the lining of the oven chamber and (ii) combusting a fuel gas from at least one other oven chamber in a top space of the oven chamber in a flame of at least one oxygen-enriched burner in the oven chamber and at least partially reducing the iron ore and forming DRI and discharging gases from the oven chamber through passageways in a wall and a floor of the oven chamber and further combusting combustible gases in the discharged gases and transferring heat to the wall and the floor of the oven chamber as the gases move through the passageways and thereby contributing to the thermal mass of the non-recovery oven and heat transfer to the oven chamber;
c) on reaching a first predetermined trigger point of the batch oven described herein, discharging at least a portion of gases from the oven chamber, without passing the gases through passageways in the floor of the oven chamber, and using these gases as a fuel gas in subsequent combustion heating in other batch oven chambers of the battery; and
d) on reaching a second predetermined trigger point of the batch oven described herein, stopping discharging gases from the oven chamber in step c) and re-commencing step b); and
e) at the end of the batch cycle discharging DRI from the oven.

It is noted that there may be situations in which the second predetermined trigger point is not reached, in which case the method includes the above-mentioned steps a), b), c), and e).

The method may include selecting the batch cycle of each of the batch ovens, including the start times of the oven heating cycles for the batch ovens and the operating parameters for above-mentioned steps b), c) and d) in the batch ovens, to optimise the operation of the batch ovens across the batch ovens and optionally taking into account other factors, such as (a) upstream iron ore and biomass production and supply factors and (b) downstream DRI use factors. By way of example, the method may include staggering the batch cycles of the batch ovens to match the fuel gas generation and fuel gas supply requirements across the batch ovens.

The term “non-recovery oven” is understood herein to mean a battery of ovens, with each oven having an oven chamber in which volatiles evolved during heating of iron ore and biomass in each oven chamber and reduction gases generated from reduction of iron oxides are not recovered as by-products for separate use, but are combusted (to the extent they are combustible) in the oven chambers themselves in the presence of oxygen, and the heat therefrom primarily used to heat the oven chamber and its contents. The term “non-recovery oven” does not exclude an oven having an oven chamber in which additionally the heat energy of the flue gases is recovered in the form of steam before the gases are discharged to the atmosphere. Likewise, the term “non-recovery oven” does not preclude the use of supplementary fuel gas (arising from downstream steelmaking or elsewhere) that is fed into an oven chamber for combustion in the chamber. While the term “non-recovery oven” is used here in the singular (with a plurality of oven chambers) i.e. the oven chambers form one contiguous oven, the invention is not limited thereby and there may be one or more than one adjacent ovens (each with their own oven chamber(s)) that do not share oven chamber walls, but are closely interconnected through a communal header/gas collection system (for fuel gas cooling and cleaning) and their flue gas system.

The term “batch cycle” is understood herein to mean an operating cycle in which an oven chamber is periodically and systematically charged with iron ore and biomass and operated in a batch cycle to produce DRI, which once produced is then discharged from the oven chamber, for example by pushing (essentially all) of the product out of the oven to await for a new charge of iron ore and biomass. Typically, the time between charging and discharging an oven chamber is 30-60 hours, but it can be outside this range through influences like size of batch charge and amount of supplemental fuel gas used. The median time taken for each batch cycle occurring in a non-recovery oven is referred to as the “batch cycle time”.

The term “hot” is understood herein to mean that the oven chamber has retained heat, i.e. the thermal mass of the refractory bricks in the oven chamber, at the end of a previous cycle. Typically, the retained heat is at least 50% of the thermal mass of the refractory bricks in the oven chamber, at the end of a previous cycle.

The term “composite of iron ore and biomass” is understood herein to mean iron ore and biomass which has been brought into close contact, for example, through compaction or alternatively through mixing and binding of the iron ore and biomass together.

The term “biomass” is understood herein to mean living or recently living organic matter. Specific biomass products for a composite of iron ore and biomass include, by way of example, forestry products (in the form of woodchips, sawdust and residues therefrom), agricultural products and their by-products (like sorghum, hay, straw and sugar cane bagasse), agricultural residues (like emerald pits and nut shells), macro and micro algae produced in an aquatic environment (like Azolla), and animal wastes. The iron ore may be any suitable type of iron ore such as magnetite, hematite and/or goethite. However, it does not preclude other iron rich ores from which iron may be extracted such as limonitic laterites, titaniferous magnetite and vanadiferous magnetite due to the local unavailability of the more usual forms of iron ore from which iron is traditionally extracted.

The term “trigger point” is understood herein to mean a point, for example indicated by an operational signal, in a batch cycle at which it is advantageous to adjust (a) a fuel gas supplied to an oven chamber or (b) gases leaving the oven chamber or (c) a combination of fuel gas supplied to the oven chamber and gases leaving the oven chamber.

The “trigger point” may be based on one or more of a number of factors. For example, the “trigger point” may be temperature-based, heating time-based, off gas flow-based or any other relevant measure that correlates to a decision to capture excess fuel gas from an oven chamber for use elsewhere, for example in another oven chamber, or a decision to increase the amount of fuel gas fed into the oven chamber to supplement the amount of fuel gas already available for combustion in the chamber. Typically, the “trigger point” is set by changes in the off-gas flow.

The above-mentioned “operational signal” may be any signal relating to operational parameters, such as temperature, heating time, off gas flow, or other parameter at any suitable location.

The term “oxygen-enriched” is understood herein to mean any one of pure oxygen, commercial oxygen, and oxygen-enriched air, where the term “oxygen-enriched air” is understood to mean air+additional oxygen.

The method makes it possible to accommodate slow iron ore-biomass heat transfer rates, which are particularly an issue when iron ore and biomass are in the form of briquettes. The invention makes it possible to have greatly extended heating times (typically 100-300 times longer than other options). Temperature driving forces can also be lower in such a system, hence making it possible for a greater proportion of the biomass energy to be captured and used for heating (thereby reducing the need for imported electric power). This translates to higher thermal efficiency and lower overall operating cost compared to other options mentioned above.

The method differs from traditional coke-making approach (besides the product being processed therein) in a number of ways.

One difference is due to biomass containing only about half the calorific value of an equivalent mass of coal. Thus, in a typical batch of composite of iron ore and biomass, such as a briquette, where the amount of biomass is 30-40% by weight (wet basis) of the total amount of biomass and ore, there will not be excessive amounts of fuel gas derived from biomass that is available for any by-product recovery and use, in addition to that required for oven fuel gas requirements. As available fuel gas will need to be used carefully—with this in mind, typically the top space burners need to be fired with a rich oxygen mix so as to avoid significant amounts of imported supplementary fuel such as natural gas being required (apart from as a start-up fuel and possibly a small pilot flame amount to satisfy safety concerns).

Accordingly, typically the method requires the use of a plurality of oxygen-enriched (which term includes oxygen-enriched air-feed) top space burners within each oven chamber so as to ensure that there is maximum use of combustible gases in the top space (from a heating context).

The use of such oxygen-enriched top space burners is another difference over the traditional non-recovery coke ovens where typically primary combustion air is introduced through ports in the oven doors to partially burn the volatiles; with secondary air also being introduced in the heating flue system under the oven sole. The secondary air that is introduced into the sole flues, that usually run in a serpentine fashion under the oven bed, completes the combustion of the gases before being discharged through a flue gas system to the atmosphere. In accordance with the invention such secondary combustion (due the calorific leanness of the gas at times during the heating process) will also require oxygen fed burners.

Typically, the burners are either (i) distributed along the top of the oven chamber or (ii) aligned more or less horizontally along the long axis to assist in ensuring a generally uniform heating pattern along the length of the chamber and to achieve direct heat transfer from the top of the chamber.

The amount of oxygen fed to each burner in each chamber may be adjusted to reflect different heating stages and/or to compensate for established variations in fuel gas flow across the chamber.

For the avoidance of doubt, as seen in some types of non-recovery ovens, the oven chamber can be effectively compartmentalised so that there is a combustion chamber and a reduction chamber, with heat coming through the refractories between to heat the composite of iron ore and biomass rather than by direct heat transfer from the top of the chamber.

The method may include supplying fuel gas to the burners in the batch oven chamber in an early (and also possibly in a late) stage of a batch cycle and generating heat via the oxygen-enriched burners. Typically, the fuel gas from other batch oven chamber is necessary to meet the heating requirements for the early (and also possibly in the late) stages of a batch cycle. In other words, insufficient heat is typically generated from biomass and other reactions in a batch oven chamber to achieve/maintain a required minimum temperature, i.e. thermal mass, in the batch oven chamber during the early (and also possibly in the late) stages of the batch cycle and the additional fuel gas closes the heat gap.

Step c) may include discharging at least a portion of the gases from the oven chamber without passing the gases through passageways in the wall and the floor of the oven chamber and using the gases as a fuel gas in subsequent combustion heating in other batch oven chambers of the battery.

Step b) may include discharging gases from the passageways through a flue gas system to the atmosphere. The flue gas system may include any suitable gas treatment systems, such as scrubbers, etc, so that the gases discharged to the atmosphere meet or exceed environmental standards.

Step b) may include operating the or each oxygen-enriched burner with a nominally cold oxygen-air mixture with a minimum of 25% oxygen in the air-oxygen mixture (calculated as a mixed stream regardless of whether or not air and oxygen are (a) actually pre-mixed or (b) fed independently as two individual streams to the gas burners).

The batch of the composite of iron ore and biomass charged into the batch oven in step a) may include 20-50% by weight biomass on a wet (as-charged) basis of the total weight of the batch.

The balance of the batch of the composite of iron ore and biomass charged into the batch oven in step a) may include (i) iron ore and (ii) flux/binder materials and (iii) optionally carbonaceous material, which may be coal or pre-charred biomass, in an amount of <5% by weight of the total weight of the batch.

The batch of composite of iron ore and biomass charged into the batch oven in step a) may include 30-40% by weight on a wet (as-charged) basis of the total weight of the batch.

Step b) may include heating iron ore and biomass to a temperature in a range of 800-1300° C., typically 800-1000 □C, in the batch cycle time.

The batch cycle time in step b) may be in a range of 30-60 hours.

The method may include forming the composite of iron ore and biomass for the batch for step a) by roll pressing an iron ore biomass mix into slab form (whether now remaining in such slab form or in broken pieces thereof).

Step a) may include forming some of the biomass charged into the batch oven as a layer or a sheet.

Step a) may include forming the composite of iron ore and biomass on a discrete layer of biomass in the batch oven.

The composite of iron ore and biomass in the batch charged into the batch oven in step a) may include briquettes.

Step e) may include discharging DRI from the oven into a product handling system that is configured to prevent bulk ingress of oxygen-containing gases and allows transportation in a hot state away from the non-recovery oven.

The product handling system may comprise either a sealed container or a different type of product handling system that prevents air contact with the hot product.

In the case of a sealed container, the container for receiving DRI discharged from the oven chamber at a discharge point in step e) may be any suitable shape and size and structure.

The container may be configured to be readily sealed. Without steps taken to control the amount of oxygen available to the direct reduced iron, the DRI will be consumed by pyrophytic reaction, i.e. the reduced iron in the DRI will rapidly oxidise, burn and likely become partially liquid.

The term “readily sealed” in the context of the container is understood to be a container that has an opening to receive hot DRI and a closure that closes that opening after receiving hot DRI. It is not necessary that such a closure makes the container gas tight, only that the closure is sufficient to seal the opening to restrict massive ingress of air.

The invention also provides a non-recovery oven, as described herein, for producing direct reduced iron (DRI) from iron ore and biomass comprising a plurality of separate batch ovens, with each batch over having a chamber defined by a refractory-lined wall and floor having a thermal mass and a plurality of oxygen-enriched burners, with the wall and the floor of each oven chamber having a plurality of passageways for transferring gases from the oven chamber and heating the refractories in the wall and the floor as the gases pass through the passageways, a gas collection and gas sharing assembly interconnecting the batch ovens, the gas collection and sharing assembly including a communal header and pipes extending between the batch ovens and the header for supplying fuel gas from the oven chambers to the header and for supplying fuel gas from the header to the oven chambers.

The plurality of the burners may be spaced along the length of the oven chamber.

The plurality of burners may be spaced also across the width of the oven chamber.

The non-recovery oven may include a product handling system for DRI discharged from the batch oven chamber that is configured to prevent bulk ingress of oxygen-containing gases and allow transportation in a hot state away from the non-recovery oven.

The invention also provides a method for producing molten metal (such as pig iron or steel) from DRI produced in the above-described method for producing direct reduced iron (“DRI”) from iron ore and biomass using the above-described non-recovery batch oven.

### BRIEF DESCRIPTION OF THE DRAWINGS

The present invention is described further by way of example with reference to the accompanying drawings, of which:

FIG. 1 is a schematic diagram of one embodiment of a process and apparatus for producing direct reduced iron (“DRI”) from iron ore and biomass which includes a plurality of batch ovens; and

FIGS. 2, 3 and 4 are process flowsheet diagrams illustrating an embodiment of the method for producing direct reduced iron (“DRI”) from iron ore and biomass in one of the batch chambers of FIG. 1 by capturing the process at each of the different gas handling stages within the method.

### DESCRIPTION OF EMBODIMENTS

As noted above, the invention is based on a realisation that an adapted form of a non-recovery coke oven is an opportunity to provide an efficient way of heating and reducing ore-biomass on a batch basis.

As noted above, in broad terms, the present invention provides a method for producing direct reduced iron (“DRI”) from a composite of iron ore and biomass as described herein that has been charged into a chamber of a batch oven in a battery of linked batch oven chambers of a plurality of batch ovens. The method includes heating iron ore and biomass in the oven chamber of the batch oven using a plurality of oxygen enriched burners, as described herein, in a top space of the chamber to a temperature range of 800-1300 □C in a batch cycle time of typically in a range of 30-60 hours and reducing iron ore and forming DRI having a metallisation of at least 85% and generating a fuel gas. The method includes combusting at least some of the fuel gas and heating the iron ore and biomass in the oven chamber. The method includes diverting some of the fuel gas for subsequent use (such as for use in oxygen enriched burners in other batch oven chambers). The method also includes discharging the DRI at the end of the batch cycle into a product handling system in the form of a container that can be sealed to prevent substantial ingress of oxygen and discharging off-gas that has been fully combusted during the course of the batch cycle.

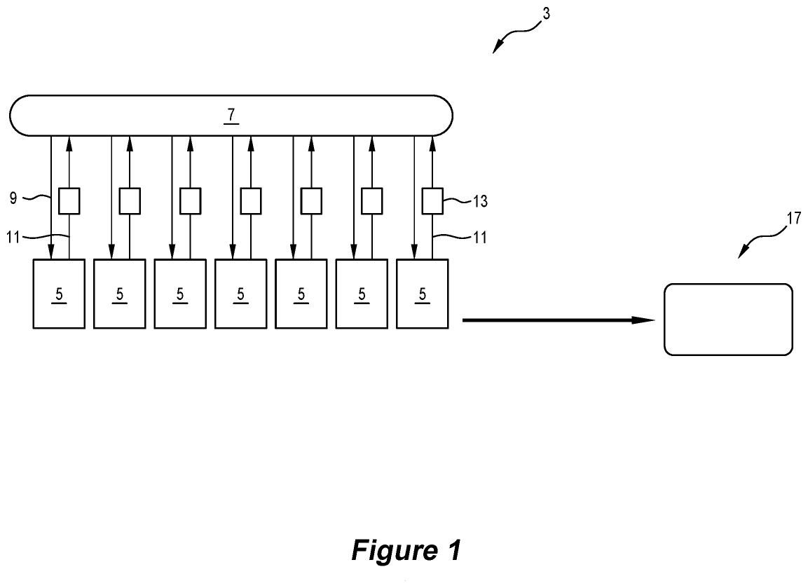

FIG. 1 is a schematic diagram of one embodiment of apparatus used for producing direct reduced iron (DRI) according to the method from composite of iron ore and biomass based on a plurality of batch ovens.

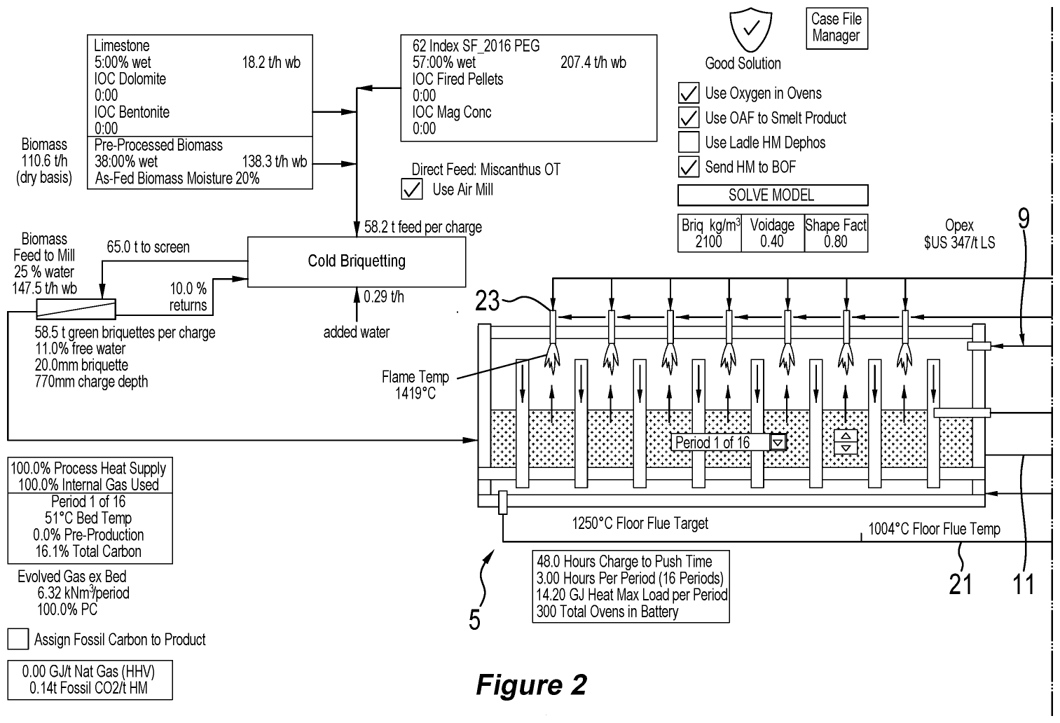

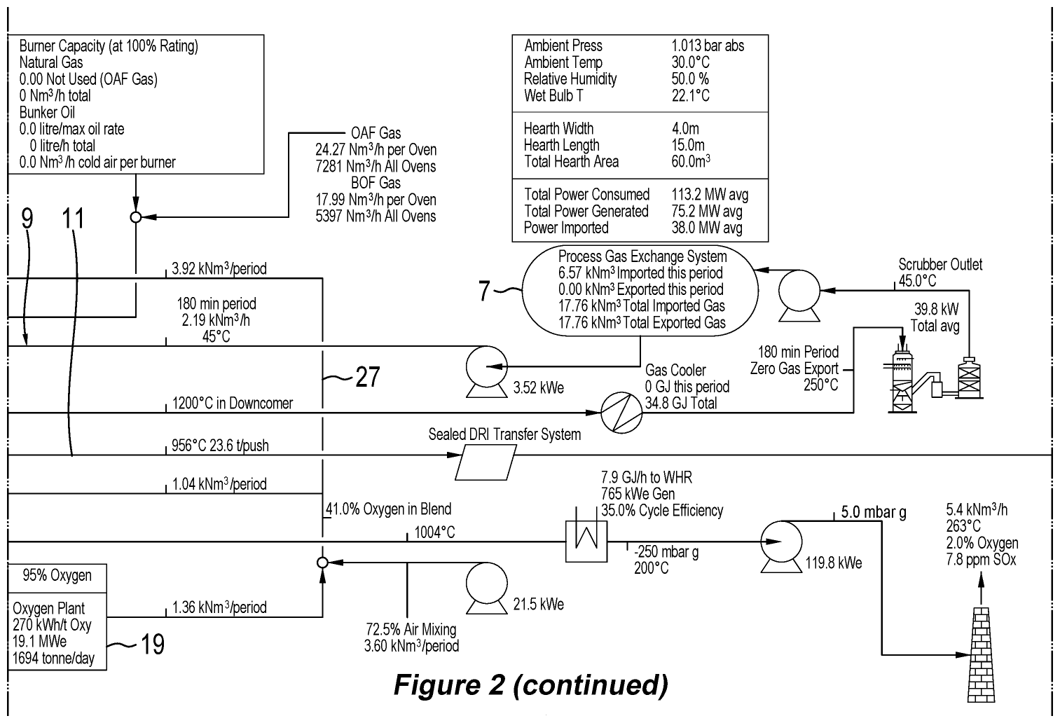

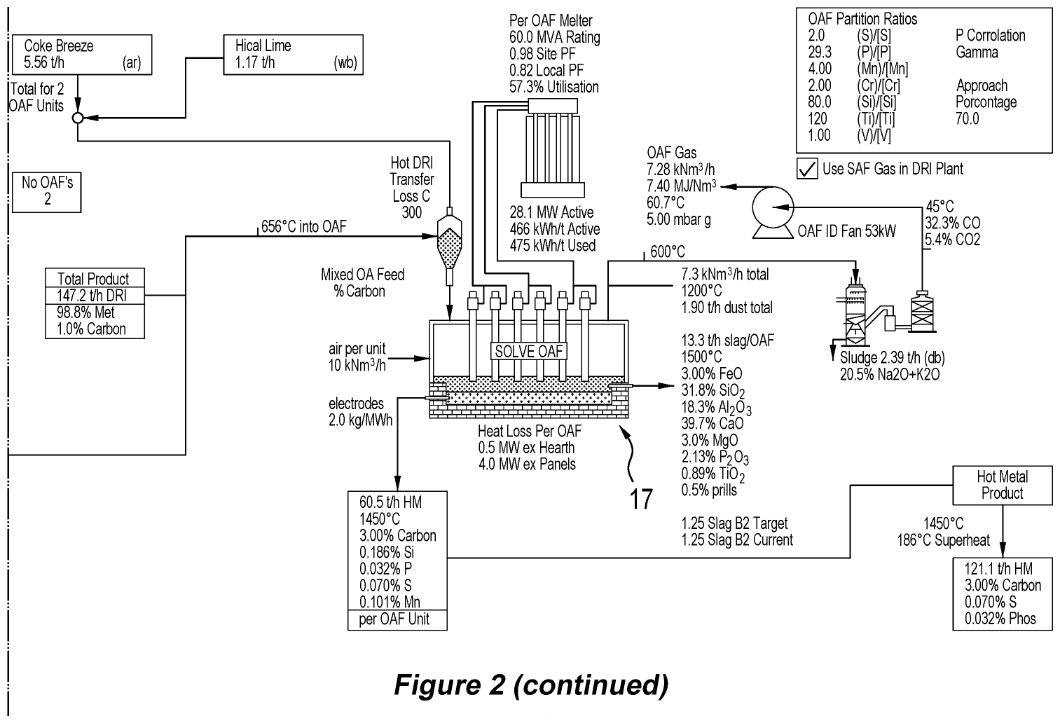

With reference to FIG. 1, the apparatus, generally identified by the numeral 3, includes (a) a plurality of batch ovens 5 arranged in a line (i.e. forming a battery) and (b) gas collection and sharing assembly, interconnecting the batch ovens 5, with each batch oven 5 having a batch oven chamber (not shown in FIG. 1 but evident from FIGS. 2-4) defined by a refractory-lined wall and floor having a thermal mass and a plurality of oxygen enriched burners 23 (see FIGS. 2-4) in a top space of the chamber.

The gas collection and sharing assembly includes a communal header 7 and pipes 9, 11 extending between the batch ovens 5 and the communal header 7 for supplying fuel gas to the header and supplying fuel gas from the header 7 to the chamber of the batch ovens 5 as required. The pipes 11 can supply fuel gas from the batch ovens 5 to the communal header 7. The pipes 9 can supply fuel gas from the communal header 7 to the batch ovens 5. The above described gas collection and sharing assembly will collectively hereafter be called the gas exchange system.

In use, by way of overview of a typical embodiment of the method, the batch ovens 5 that are in early (and also possibly in late) parts of a batch cycle receive fuel gas from other batch ovens 5 via the communal header 7 and pipes 9 and generate heat via the oxygen-enriched burners. This fuel gas from other batch ovens is necessary to meet the heating requirements for the early (and also possibly in the late) stages of a batch cycle. In other words, insufficient heat is typically generated from biomass and other reactions in a batch oven 5 to achieve/maintain a required minimum temperature, i.e. thermal mass, in the batch oven 5 during the early (and also possibly in the late) stages of the batch cycle.

In addition, in use, batch ovens 5 that are in middle (fuel-rich) stages of the cycle transfer fuel gas from the batch ovens 5 via the pipes 11 to the header 7. In this stage of the cycle, there is excess fuel gas to that required to generate sufficient heat to achieve/maintain a required minimum temperature in the batch oven 5. This fuel gas will be hot at the extraction point, and therefore the gas collection and sharing equipment includes a cooling element 13 that cools the fuel gas before it is admitted into the communal header 7.

The cooling element 13 may be any suitable cooling element. By way of example, the cooling element may be in the form of a wet scrubber or an indirect heat exchanger (e.g. long pipes with water or air cooling on the outside). Typically, the communal header 7 and heat exchanger include systems to manage condensation and corrosion issues in such a way that they do not interfere with the process.

It is noted that FIG. 1 illustrates a line of seven (7) batch ovens 5. The invention is not confined to this number of batch ovens 5. Typically, the number of batch ovens 5 is 6-10 ovens. However, in any given situation, the number of batch ovens 5 in a cluster will be a function of oven size and physical constraints of arranging batch ovens and gas collection and sharing equipment in an efficient arrangement.

The batch ovens 5 may be any suitable form.

By way of example, the batch ovens 5 may be an adapted non-recovery coke oven, with (a) refractory-lined wall and floor defining an oven chamber and providing thermal mass for the oven and (b) passageways in the wall and the floor that, in use transfer gases from the chamber to an external flue gas system, with resultant heat transfer to the refractories in the wall and the floor, thereby contributing to the thermal mass of the non-recovery oven and heat transfer to the oven chamber. As noted above, U.S. Pat. No. 5,318,671 in the name of Sun Coal Company describes a non-recovery coke oven.

While there are a number of different design variations for non-recovery coke ovens, with U.S. Pat. No. 5,318,671 being one design variation, those skilled in such art would be able to adapt such designs to utilize the invention described herein, after the invention has been disclosed to them.

In use of a batch oven 5, a batch of the composite of ore and biomass as described herein is charged into the oven chamber of the batch oven 5 prior to the commencement of a batch cycle and is pushed out of the chamber (in the form of DRI) at the end of the batch cycle. In such style of batch ovens, typically there is a charger car and a separate pusher, both on the same rails with the rails extending beyond the ends of the battery to enable the charger car and the pusher to move out of the way of each other when carrying out their function on the batch ovens at the end of the battery.

Ore and the majority of biomass should preferably be in quite close contact with one another for the method to work efficiently. Any method of achieving this composite of ore and biomass may be used, briquetting being just one example. Other options may involve ore-biomass mixing followed by roll pressing into slabs that break up naturally (or are deliberately broken up) prior to charging. It may also be possible to use some form of non-agglomerated charge into the ovens such as alternate layering of ore and biomass (somewhat akin to stamp-charging). It may also be advantageous in having a separate layer of biomass as part of the charging process that sits on the floor of the oven chamber. This may over time assist in the reduction of wear to the floor through the charging of the composite of iron ore and biomass. Likewise, it may assist (through some residual thereof remaining) in the reduction of wear to the floor through the discharge of DRI when pushing that material from the chamber.

For illustration purposes the following description uses composites in the form of ore-biomass briquettes.

The briquettes may be manufactured by any suitable method. By way of example, measured amounts of iron ore fines and biomass and water (which may be at least partially present as moisture in the biomass) and optionally flux is charged into a suitable size mixing drum (not shown) and the drum rotated to form a homogeneous mixture. Thereafter, the mixture may be transferred to a suitable briquette-making apparatus and cold-formed into briquettes.

In one embodiment of the invention, the briquettes are roughly 20 cm³ in volume and contain 30-40% biomass (e.g. elephant grass at 20% moisture). A small amount of flux material (such as limestone) may be included, with the balance comprising iron ore fines.

In one embodiment of the invention, the process begins with a layer of (typically) 800 mm deep ore-biomass briquettes charged into an oven chamber of a batch oven 5. While charging may be done in any manner, a suitable manner would be that akin to how stamp charging of a non-recovery coke oven is carried out.

During an initial heating stage of the method in a batch oven 5, heat in the oven chamber produces water and no or insufficient combustible gases, i.e. fuel gases, to support a flame for the plurality of oxygen enriched burners in the top space of the chamber of the batch oven 5. However, at a later stage in the process, the briquette bed will produce fuel gas to that required to generate heat required to maintain a required minimum temperature for the batch oven 5. At this point, which is a trigger point, excess fuel gas may be harvested (for example, from wall downcomers of the batch oven 5) as described above via pipes 11 transferring a portion of the fuel gas to the communal header 7 for use in other batch ovens 5 at different, fuel gas-deficient stages of the process.

It is noted that, in use, in a typical embodiment of the method, a batch oven 5 will be pre-heated to an extent before a batch of composite of iron ore and biomass is charged into the chamber of the batch oven 5 so that there is at least some thermal mass in the lining of the chamber.

A typical embodiment of the method includes the following steps in at least one batch oven:
a) charging a batch of composite of iron ore and biomass into the chamber of one of the batch ovens 5 shown in FIG. 1 under a negative pressure, noting that the pressure may be any suitable pressure;
b) heating the charged iron ore and biomass in the oven chamber by a combination of heat from (i) the thermal mass of a lining of the oven chamber and (ii) combusting a fuel gas from at least one other oven chamber in a top space of the oven chamber in a flame of at least one oxygen-enriched burner in the oven chamber and at least partially reducing the iron ore and forming DRI and discharging gases from the oven chamber through passageways in a wall and a floor of the oven chamber and further combusting combustible gases in the discharged gases and transferring heat to the wall and the floor of the oven chamber as the gases move through the passageways and thereby contributing to the thermal mass of the non-recovery oven and heat transfer to the oven chamber;
c) on reaching a first predetermined trigger point in the batch oven 5, discharging gases from the oven chamber, without passing the gases through passageways in the floor of the oven chamber, and using the gases as a fuel gas in subsequent combustion heating in other batch oven chambers of the battery; and
d) on reaching a second predetermined trigger point in the batch oven, stopping discharging gases from the oven chamber in step c) and re-commencing step b); and
e) at the end of the batch cycle discharging DRI from the oven chamber.

The “trigger point” may be based on one or more of a number of factors. For example, the “trigger point” may be temperature-based, heating time-based, off gas flow-based or any other relevant measure that correlates to a decision to capture excess fuel gas from an oven chamber for use elsewhere, for example in another oven chamber, or a decision to increase the amount of fuel gas fed into the oven chamber to supplement the amount of fuel gas already available for combustion in the chamber. Typically, the “trigger point” is set by changes in the off-gas flow. The above-mentioned “operational signal” may be any signal relating to operational parameters, such as temperature, heating time, off gas flow, or other parameter at any suitable location.

Once the batch process cycle is complete in a batch oven, the DRI is removed from the batch oven 5 via a product handling system. For example, the DRI is pushed out of the batch oven into an insulated container (not shown) that prevents ingress of oxygen-containing gases for transportation of the DRI in a hot state away from the batch oven 5.

The physical structure of the DRI at the end of the process is not critical. The physical structure may be friable and break easily or it could resemble a robust 3D “chocolate bar”.

Typically, the insulated container is transported (hot) to a downstream electric melting furnace 17. Here, a feed system (not shown in FIG. 1) will accept the hot container and pass the DRI through a system of (for example) pushers and breaker bars (not shown in FIG. 1) in order to feed the DRI into the furnace, including any furnace bath.

It is noted that those structural components that are not specifically shown in FIG. 1 are generally standard components and the skilled person would be able to make an appropriate selection of the components.

It is noted that there is no requirement to break up the DRI completely to supply to the electric melting furnace 17—only into lumps small enough to constitute more or less steady feed into the furnace from a metallurgical control point of view. It is expected that fairly large lumps (e.g. 20-30 briquettes clumped together) could pass through such a system without causing any issues.

FIGS. 2-4 are process flowsheet diagrams illustrating different parts of one embodiment of a process and apparatus for producing direct reduced iron (DRI) according to the method of the invention from cold-formed briquettes of iron ore and biomass in one of the batch ovens 5 of FIG. 1.

The process flowsheet diagrams of FIGS. 2-4 also illustrate transferring the DRI from the batch oven 5 to an electric melting furnace 17 and operating the furnace to produce molten metal, in accordance with one embodiment of a process and apparatus for producing molten metal (such as cold pig iron or steel) from DRI.

The data in the diagrams of FIGS. 2-4 is derived from a model developed by the applicant.

The process and apparatus shown in FIG. 2 illustrates the start of the embodiment of an oven heating cycle according to the method (the first 3 hours of a 48-hour cycle) for one batch oven 5.

It is noted that the oven heating cycle of FIGS. 2-4 may apply to any one of the batch ovens 5 in the array shown in FIG. 1. It is also noted that the start times of the oven heating cycles for the batch ovens 5 shown in FIG. 1 may be staggered to match the fuel gas generation and fuel gas supply requirements across the batch ovens 5. It is also noted that different oven heating cycles may be used in the batch ovens 5 in FIG. 1 to optimise operational efficiency in relation to fuel gas utilisation (or other factors, such as upstream briquette production and supply factors and downstream hot metal production factors).

With further reference to FIG. 2, in the described embodiment, a 59-tonne cold-formed briquette bed is charged into a chamber of a hot batch oven 5 (where “hot” means that the batch oven 5 has at least 50% of the residual heat of processing the last batch of DRI) that is 4 m wide by 15 m deep (800 mm bed depth). The briquettes comprise 38% elephant grass at 20% water, 5% limestone and 57% Pilbara Blend iron ore fines. The charge is cold and only water vapour is released during the 3-hour period. Fuel gas largely originating from other batch ovens 5 (see FIG. 1) in the “fuel production” stages of their cycle is drawn from the gas exchange system 10. The fuel gas, supplied to batch oven 5 via a line 9, is burned with an air-oxygen mixture containing 41% oxygen in burners 23 in batch oven 5. Oxygen is produced via cryogenic air separation in an oxygen plant 19 in a conventional way and supplied to the burners via a line 27. Off-gas generated in the batch oven 5 is discharged from the batch oven and transferred via a line 21 for downstream processing and release to the atmosphere.

Downstream processing of DRI briquettes produced in the batch oven 5 involves melting the DRI in an electric furnace (OAF) 17 to produce hot metal, followed by conversion to steel in a BOF. Both the OAF and the BOF generate combustible fuel gas streams—although small in terms of overall energy demand—these gas streams are nevertheless used in the batch oven burners as supplementary fuel by feeding those gas streams into gas exchange system 10.

In this 3-hour period (as shown in FIG. 2) 6570 Nm³ fuel gas originating from other batch ovens is imported through gas exchange system 10, augmented by 72.9 Nm³ OAF gas and 54.0 Nm³ BOF gas.

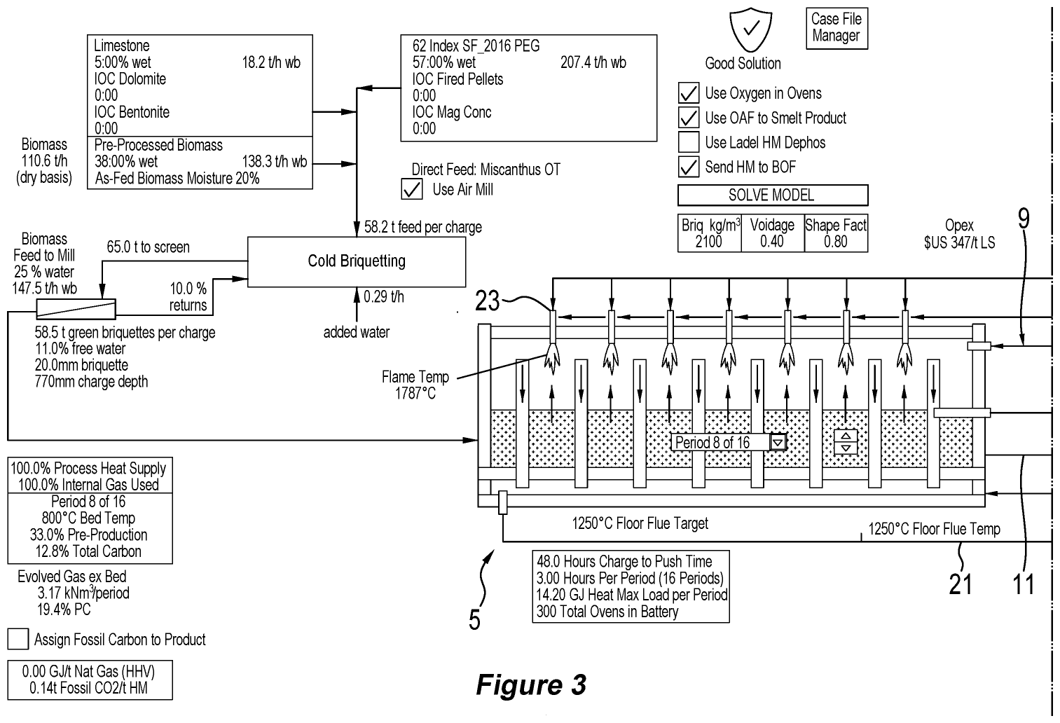

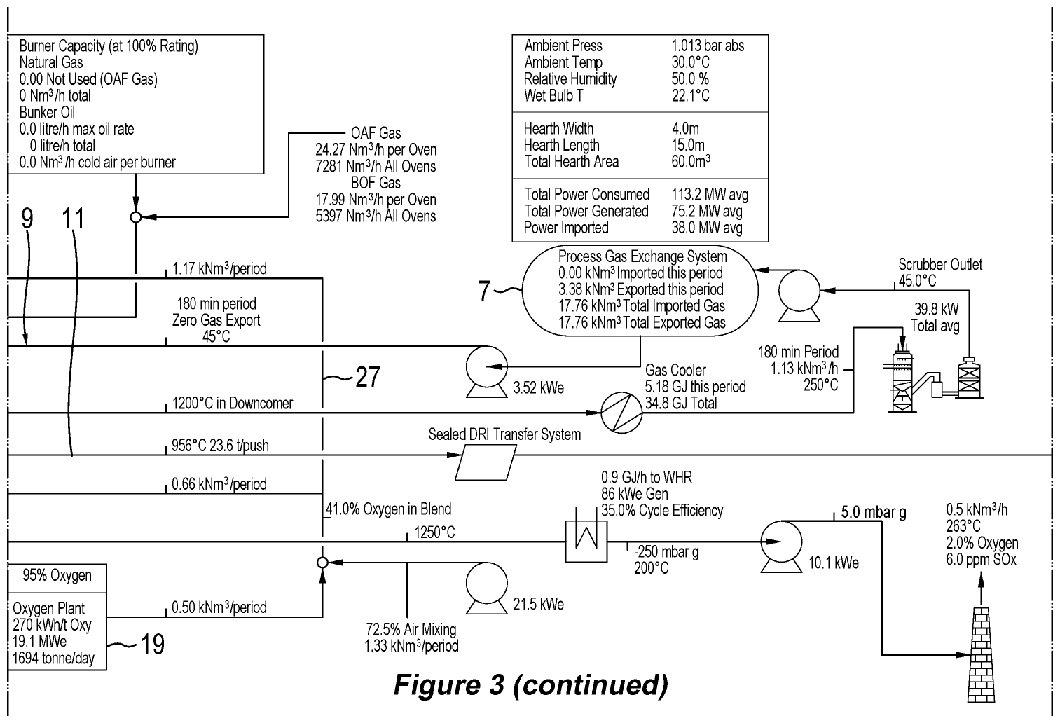

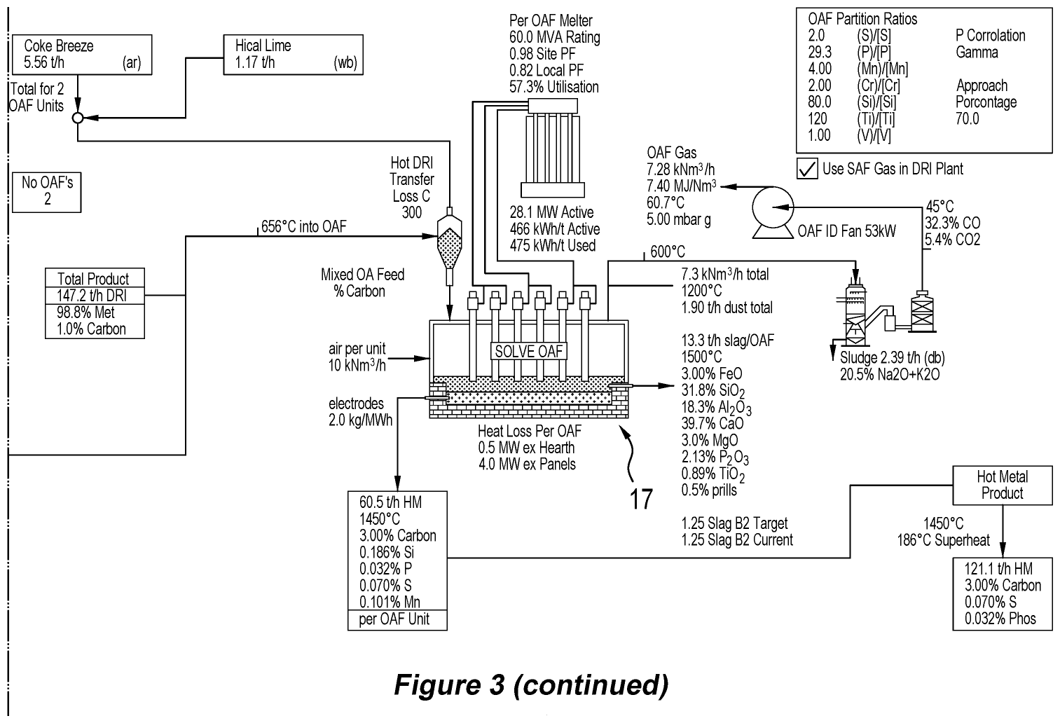

FIG. 3 shows a 3-hour period in the middle of the 48-hour batch cycle when fuel gas is being produced in the batch oven 5 shown in the Figure is more than the amount required to generate sufficient heat to maintain a required minimum temperature, i.e. maintain a thermal balance, for the batch oven 5. At this stage, the bed is around 800° C. and fuel gas production exceeds heat requirements by 3380 Nm³/3 h. This excess fuel gas is exported to the communal header 7 for use by other batch ovens 5. Typically, the gases generated in the chamber are transferred to the header 7 via the pipe 11 and the cooling element 13 shown in FIG. 1 without passing through the passageways in the wall and the floor of the oven chamber. In an alternative arrangement, typically, the gases discharged from the chamber pass through passageways in the wall of the chamber and then to the header 7 via the pipe 11 and the cooling element 13 and bypass only the passageways in the floor of the batch oven 5.

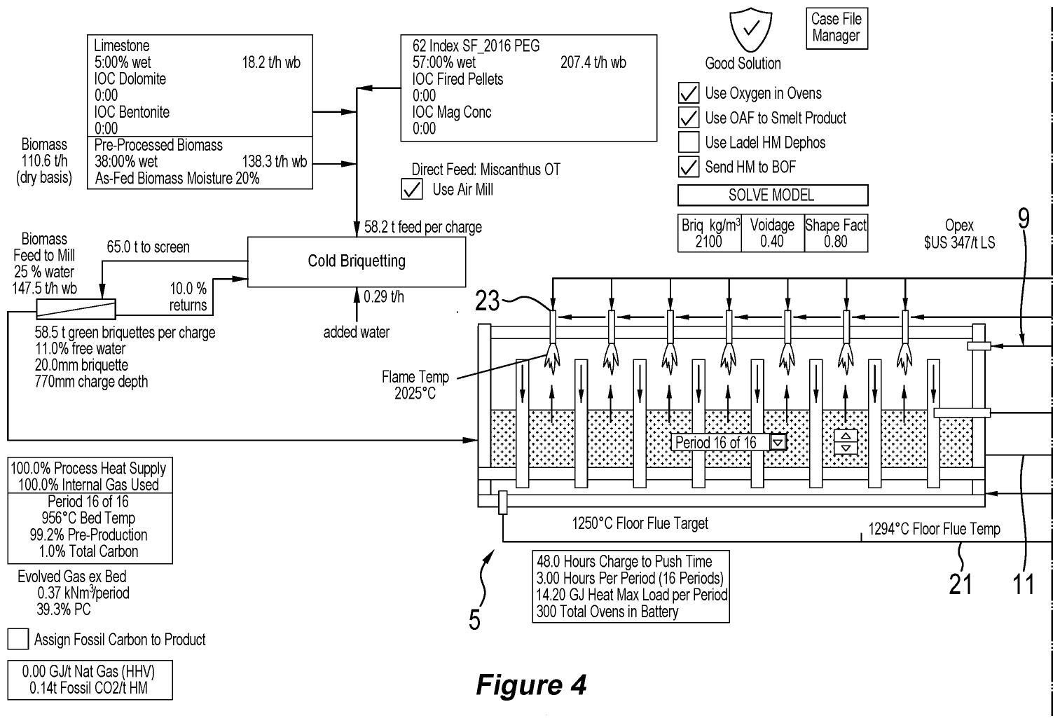

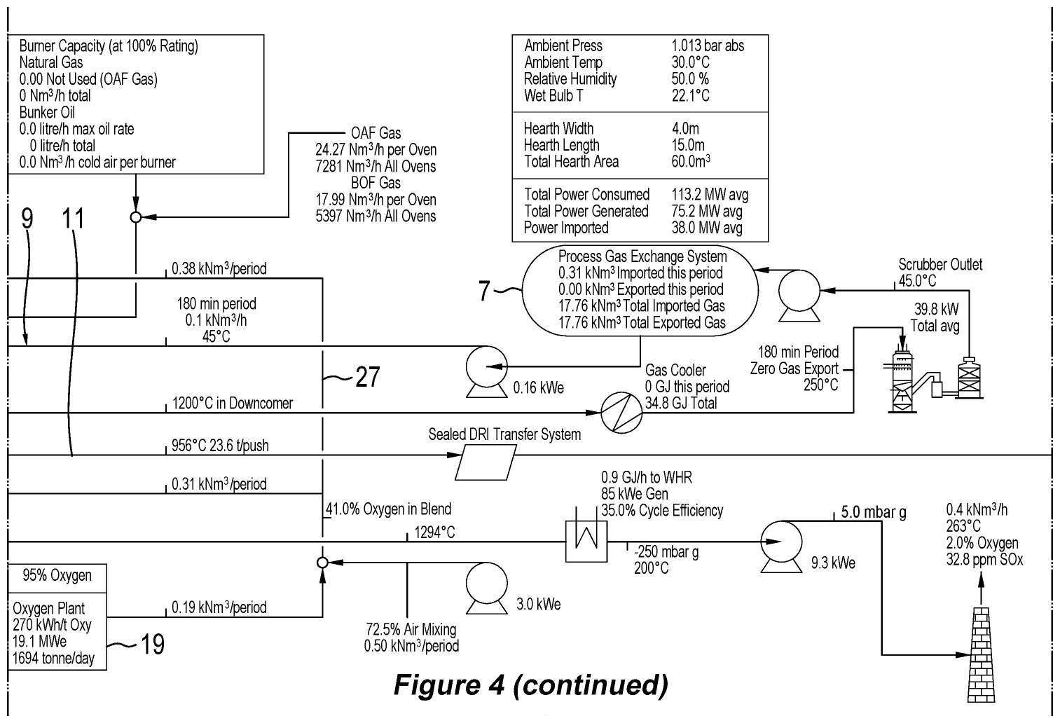

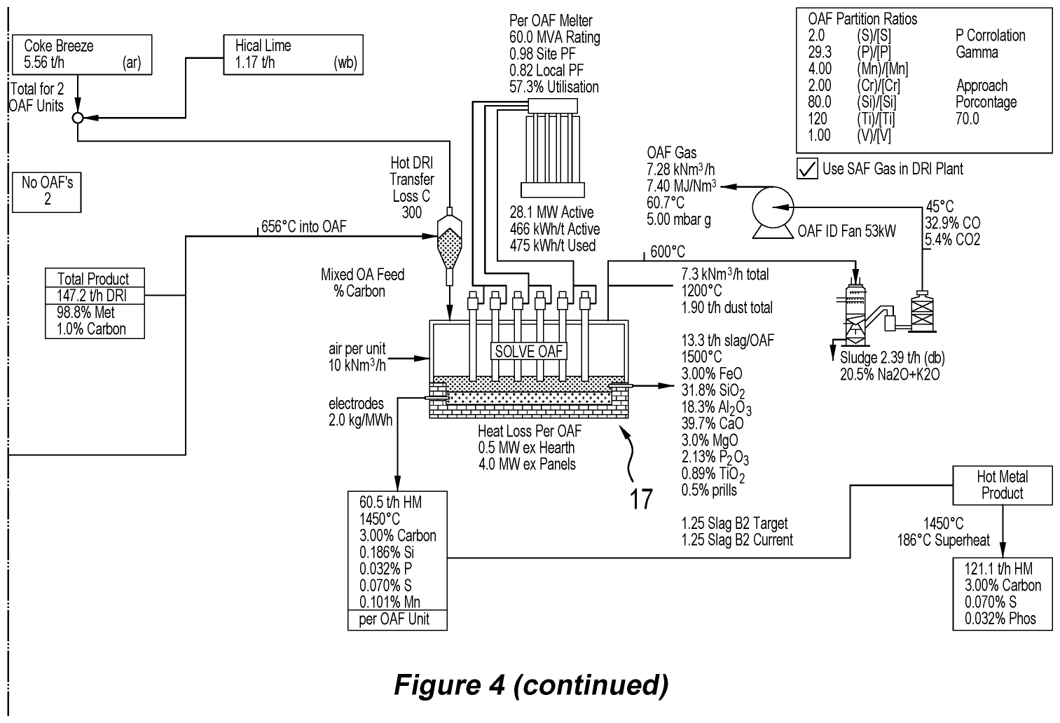

FIG. 4 shows the final 3 hours of the 48-hour batch cycle. At this point the bed has reached 956° C. and metallisation is around 98-99%. In this instance, a small amount of imported fuel gas (310 Nm³/3 h) is needed to sustain a thermal balance.

This example necessarily contains multiple assumptions regarding kinetic parameters—precise details may shift as a result of different kinetics. However, the principles are not expected to change substantially—in particular, the sharing of fuel gas between batch ovens 5 within an oven cluster (see FIG. 1) such that each oven 5 produces and receives fuel gas, typically around the same amount of fuel gas, in the overall integrated cycle. Although the current example is based on a constant air-oxygen blend to the gas burners (41% oxygen by volume), it is expected that the ratio of air to oxygen could be varied as an additional control parameter to further optimise the process.

Around 60-70% of the required plant electric power (including power needed for the electric melting furnace and the oxygen plant) is generated from residual heat in the flue gas (and fuel gas) from the ovens.

After the final 3 hours of the 48-hour batch cycle has elapsed, the bed of DRI is pushed out from the batch oven 5 and transferred to the OAF unit 17 (which may operate in either submerged-arc or open-arc mode, the name notwithstanding). Flux and coke breeze are added in the OAF 17 to control metal carbon and slag chemistry. Hot metal (molten pig iron in this embodiment) is produced. This may be cooled and cast into pigs or passed directly (in liquid form) to a steelmaking vessel (BOF or EAF).

Many modifications may be made to the embodiment described above without departing from the spirit and scope of the invention.

By way of example, whilst the embodiment shown in FIGS. 2-4 includes a 59-tonne cold-formed briquette bed that is charged into a batch oven 5 that is 4 m wide by 15 m deep (800 mm bed depth), with the briquettes comprising 38% elephant grass at 20% water, 5% limestone and 57% Pilbara Blend iron ore fines, it can readily be appreciated the invention is not confined to this size briquette bed with this composition of the briquettes.

### REFERENCES

1. Vogl, V et al, Assessment of hydrogen direct reduction for fossil-free steelmaking, Journal of Cleaner production 203 (218) 736-745
2. Strezov, V, Iron ore reduction using sawdust: experimental analysis and kinetic modelling, renewable Energy 31(12) 1892-1905, October 2006

1. A method for producing direct reduced iron (DRI) from iron ore and biomass using a batch oven in a batch cycle mode of operation, with the oven having a plurality of separate batch ovens, with each batch oven having a chamber defined by a refractory-lined wall and floor having a thermal mass and a plurality of burners, and with the oven chambers having shared fuel gas and off-gas offtakes, with the method including the following steps in at least one batch oven:
a) charging a batch of composite of iron ore and biomass into the batch oven chamber;
b) heating the charged iron ore and biomass in each oven chamber by a combination of heat from (i) the thermal mass of the lining of the oven chamber and (ii) combusting a fuel gas from at least one other oven chamber in a top space of the oven chamber in a flame of at least one oxygen-enriched burner in the oven chamber and at least partially reducing the iron ore and forming DRI and discharging gases from the oven chamber through passageways in a wall and a floor of the oven chamber and further combusting combustible gases in the discharged gases and transferring heat to the wall and the floor of the oven chamber as the gases move through the passageways and thereby contributing to the thermal mass of the non-recovery oven and heat transfer to the oven chamber;
c) on reaching a first predetermined trigger point, discharging at least a portion of gases from the oven chamber, without passing the gases through passageways in the floor of the oven chamber, and using the gases as a fuel gas in subsequent combustion heating in other batch oven chambers; and
d) on reaching a second predetermined trigger point in the batch oven, stopping discharging gases from the oven chamber in step c) and re-commencing step b); and
e) at the end of the batch cycle discharging DRI from the oven chamber.

2. The method defined in claim 1 includes discharging gases from the passageways through a flue gas system to the atmosphere.

3. The method defined in claim 1 wherein step c) includes discharging at least a portion of the gases from the oven chamber without passing the gases through passageways in the wall and the floor of the oven chamber and using the gases as a fuel gas in subsequent combustion heating in other batch oven chambers.

4. The method defined in claim 1 wherein step b) includes operating the oxygen-enriched burner(s) with a nominally cold oxygen-air mixture with a minimum of 25% oxygen in the air-oxygen mixture (calculated as a mixed stream regardless of whether or not air and oxygen are (a) actually pre-mixed or (b) fed independently as two individual streams to the gas burners).

5. The method defined in claim 1 wherein the batch of the composite of iron ore and biomass charged into the batch oven in step a) includes 20-50% by weight biomass on a wet (as-charged) basis of the total weight of the batch.

6. The method defined in claim 5 wherein the balance of the batch of the composite of iron ore and biomass charged into the batch oven in step a) includes (i) iron ore and (ii) flux/binder materials and (iii) optionally carbonaceous material, which may be coal or pre-charred biomass, in an amount of <5% by weight of the total weight of the batch.

7. The method defined in claim 1 wherein the batch of composite of iron ore and biomass charged into the batch oven in step a) includes 30-40% by weight on a wet (as-charged) basis of the total weight of the batch.

8. The method defined in claim 1 wherein step b) includes heating iron ore and biomass to a temperature in a range of 800-1300° C. in the batch cycle time.

9. The method defined in claim 1 wherein the batch cycle time in step b) is in a range of 30-60 hours.

10. The method defined in claim 1 includes forming the composite of iron ore and biomass for the batch for step a) by roll pressing an iron ore biomass mix into slab form (whether now remaining in such slab form or in broken pieces thereof).

11. The method defined in claim 1 wherein step a) includes forming some of the biomass charged into the batch oven as a layer or a sheet.

12. The method defined claim 1 wherein step a) includes forming the composite of iron ore and biomass on a discrete layer of biomass in the batch oven.

13. The method defined claim 1 wherein the composite of iron ore and biomass in the batch charged into the batch oven in step a) includes briquettes.

14. The method defined in claim 1 wherein step e) includes discharging DRI from the oven into a product handling system that is configured to prevent bulk ingress of oxygen-containing gases and allows transportation in a hot state away from the non-recovery oven.

15. A non-recovery oven for producing direct reduced iron (DRI) from iron ore and biomass comprising a plurality of separate batch ovens, with each batch oven having a chamber defined by a refractory-lined wall and floor having a thermal mass and a plurality of oxygen-enriched burners, with the wall and the floor of each oven chamber having a plurality of passageways for transferring gases from the oven chamber and heating the refractories in the wall and the floor as the gases pass through the passageways, a gas collection and gas sharing assembly interconnecting the batch ovens, the gas collection and sharing assembly including a communal header and pipes extending between the batch ovens and the header for supplying fuel gas from the oven chambers to the header and for supplying fuel gas from the header to the oven chambers.

16. The non-recovery oven defined in claim 15 wherein the plurality of the burners is spaced along the length of the oven chamber.

17. The non-recovery oven defined in claim 16 wherein the plurality of the burners is spaced also across the width of the oven chamber.

18. The non-recovery oven defined in claim includes a product handling system for DRI discharged from the batch oven chamber that is configured to prevent bulk ingress of oxygen-containing gases and allow transportation in a hot state away from the non-recovery oven.

19. A method for producing direct reduced iron (“DRI”) from iron ore and biomass includes heating a batch of iron ore and biomass in each oven chamber of a non-recovery batch oven by a combination (i) the thermal mass of a lining of the oven chamber and (ii) combustion of a fuel gas from at least one other oven chamber and at least partially reducing the iron ore and forming DRI, discharging gases from the oven chamber through passageways in a wall and a floor of the oven chamber and further combusting combustible gases and transferring heat to the wall and the floor of the oven chamber as the gases move through the passageways, and discharging at least a portion of gases from the oven chamber, without passing the gases through passageways in the floor (and optionally the wall) of the oven chamber, and using these gases as a fuel gas in subsequent combustion heating in other batch oven chambers when a first predetermined trigger point is reached.
